(19) United States
(12) Patent Application Publication
(10) Pub. No.: US 2005/0218328 A1
(43) Pub. Date: Oct. 6, 2005

(54) Infrared sensor

(76) Inventors: Akiko Suzuki, Tokyo (JP); Akinobu Sato, Soka-shi (JP); Emmanuel Bourelle, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/073,370

(22) Filed: Mar. 4, 2005

(30) Foreign Application Priority Data
Mar. 30, 2004 (JP) 2004-099923

(51) Int. Cl. G01J 5/02

(52) U.S. Cl. 250/353

(57) ABSTRACT

An infrared sensor which is provided with an infrared detector 43 for converting infrared light to an electric signal and an optical element 44 for guiding the infrared light to the infrared detector 43, and in which the optical element 44 is a planar optical waveguide provided with a diffraction grating and is formed on a substrate 41 side by side with the infrared detector 43. The infrared light incident on the optical element 44 from a direction vertical to the substrate surface is deflected and guided by the optical element 44 in parallel to the substrate surface for incidence on the infrared detector 43. The infrared sensor is small in size, highly sensitive, fast in responsivity, and easy to manufacture.

### BACKGROUND OF THE INVENTION

The present invention relates generally to an infrared sensor provided with an infrared detector and an optical element for guiding thereto infrared light and, more particularly, to a small, low-profile infrared sensor that achieves high infrared detection sensitivity and high-speed responsivity by increasing the quantity of infrared light incident on the infrared detector per unit area through use of an optical element capable of controlling the direction of travel of infrared light and focusing it to a spot size smaller than its wavelength.

Infrared sensors for converting infrared light from a heat source to an electric signal are roughly divided into a thermal and a quantum sensor. The thermal sensor is one that induces a temperature change in a sensor material by converting infrared light to heat through an infrared absorption layer or the like and detects a change in electromotive force, distribution of electric charge, or resistance value which is caused by the temperature change. The quantum sensor utilizes a current change, electromotive force, or electron emission which is caused by exciting a semiconductor by infrared light. Generally speaking, the quantum sensor calls for cooling, and hence it is hard to get small in size and is expensive. On the other hand, despite its inferiority in performance, for example, in sensitivity and responsivity, to the quantum sensor, the thermal sensor need not be cooled and can be made smaller in size and lower in price, and hence it is now widely used for measuring slow changes in temperature (a clinical thermometer, for instance) or for sensing a slowly moving object (an intrusion sensor, for instance).

The thermal sensor has undergone various improvements for higher sensitivity and faster responsivity. The improvements fall broadly into those in the optical system, in heat control and in electric circuitry. In the optical system an optical element such as a lens and infrared absorption parts (which absorb infrared light for conversion to heat) are configured to increase the quantity of infrared light received per unit area. In the field of heat control a heat-separating structure of the highest possible thermal resistance is introduced and an infrared absorption part is combined therewith to achieve a great temperature rise in the heat-separating structure by absorption of infrared light incident thereon. In the field of electric circuitry the signal detection efficiency for converting the temperature rise to an electric signal is enhanced, for example, by noise reduction. A description will be given below of the improvements made so far to the optical system in the case of a thermopile.

The use of a lens is the simplest method for increasing the quantity of infrared light incident on the infrared absorbing part per unit area. In Japanese Patent Application Kokai Publication Gazette H10-209414 (published Aug. 7, 1998, hereinafter referred to as document 1), there is disclosed a configuration for focusing infrared light through a microlens array onto an infrared absorbing part. An example using an optical element other than the lens is disclosed in Japanese Patent No. 3254787 (issued Feb. 12, 2002, hereinafter referred to as document 2), in which infrared-ray components, which do not directly reach infrared absorbing parts, are reflected off a reflector for reconvergence onto the infrared absorbing parts.

FIGS. 1A and 1B schematically show the configuration of the infrared sensor set forth in document 1, in which a microlens array 11 having equally-spaced microlenses 11a arranged in matrix form is formed integrally with a silicon support frame 12 fixed to a silicon substrate 13. In the surface layer of the silicon substrate 13 there disposed opposite the microlenses 11a a number of light receiving parts 14 for receiving infrared light. The light receiving parts 14 are each supported by support arms 16a and 16b in such a manner as to be suspended in a recess 15 made in the surface of the silicon substrate 13. Though not shown in detail, the light receiving parts 14 each has an infrared absorption layer for absorbing infrared light and a thermoelectric conversion element placed adjacent the infrared absorption layer. In FIG. 1B, reference numeral 17 denotes a hollow made in the inside of the support frame 12, 18 a signal transfer circuit, and 19 infrared rays that are incident on the infrared sensor and are focused by the microlenses 11a.

FIG. 2A shows the configuration of the infrared sensor described in document 2, which has an infrared detecting element 24 disposed in a cavity 23 defined by a pair of opposed semiconductor substrates 21 and 22 and a reflector 25 formed all over the inside surface area of the semiconductor substrate 22. The infrared detecting element 24 is formed on the semiconductor substrate 21. Though shown in simple form in FIG. 2A, the semiconductor substrate 21 has such a configuration as depicted in detail in FIG. 2B. In FIG. 2B, reference numeral 26 denotes a p-type silicon substrate, 27 an infrared filter formed by an n-type epitaxial layer, 28 an SiO₂ film, 29, 30 Si₃N₄ films, and 31 an infrared absorbing layer. In FIG. 2A, reference numeral 32 denotes light incident on the infrared sensor. The incident light is filtered by the infrared filter 27, through which only infrared light is allowed to directly strike on the infrared detecting element 24, and the other remaining infrared rays are reflected off and focused through the reflector 25 onto the infrared detecting element 24.

The optical system in any of the above-described thermal infrared sensors is intended to improve the infrared detection sensitivity and response speed of the sensor by increasing the quantity of absorption of infrared light per unit area. However, some problems need to be solved to provide compatibility between the demand for further increase in the quantity of infrared absorption per unit area and the demand for cost reduction by downsizing the sensor and simplification of its manufacturing process.

With the configuration disclosed in document 1, the lens and each infrared absorbing part are separated by a gap to reduce the size of the latter to substantially the same as the focused spot size of the incident infrared light to decrease the thermal capacity of the infrared absorbing part, thereby increasing its sensitivity. However, the reduction of the focused spot size calls for separating the lens and the infrared absorbing part from each other, inevitably making the sensor structure bulky. Even if they are sufficiently spaced apart, the focused spot size cannot be made smaller than the infrared wavelength. Besides, since the support frame with the lenses and the substrate with the infrared light receiving elements are different structures, it is necessary to introduce a step of assembling them into a one-piece structure with the lenses and the infrared detecting elements positioned with precision—this inevitably leads to complicating the sensor manufacturing process and increasing its manufacturing costs.

With the configuration disclosed in document 2 which uses the infrared reflector, since the spot size of the infrared light cannot be reduced, it is impossible to provide increased sensitivity by reducing the volume of the infrared absorbing part in accordance with the spot size, that is, by reducing its thermal capacity. Moreover, since the reflector and the infrared detector are formed first on different substrate and the combined, upsizing of individual elements and complication of the manufacturing process inevitably raise the manufacturing costs. Besides, since the infrared detecting part is thick, its mechanical durability to withstand to bending or the like remarkably decreases in the case of using a flexible substrate formed of a flexible plastics material.

As described above, in the optical system of the infrared sensor, it is demanded to focus infrared light to a sufficiently small spot size for reduction of the thermal capacity of the infrared absorbing part and to make the optical system itself smaller; furthermore, it is desirable to provide enhanced positioning accuracy for assembling the infrared detecting elements and the optical system into a one-piece structure, simplified manufacturing process, and increased mechanical durability of the infrared detecting elements. These demands for improvements in the optical system have become clear from the prior art examples using the thermopile as the infrared detecting element, but similar problems will still remain unsolved in the case of using other infrared detecting elements.

### SUMMARY OF THE INVENTION

It is therefore an object of the present invention to provide a miniaturized, highly sensitive, fast-responsive and highly mechanically durable infrared sensor that does not involve an assembling step in its manufacturing process and permits focusing infrared light to a spot size smaller than its wavelength and hence has remarkably small infrared absorbing parts.

According to the present invention, there is provided an infrared sensor which is provided with an infrared detector for converting infrared light to an electric signal and an optical element for guiding infrared light to the infrared detector, and wherein the optical element has an array of materials of different refractive indexes and is disposed on a substrate side by side with the infrared detector so that the infrared light incident on the infrared sensor from a direction vertical to the substrate surface is deflected through 90° to a direction parallel to the substrate surface for incidence on the infrared detector.

With the above configuration of the infrared sensor according to the present invention, the incident infrared light can be focused to a spot size smaller than its wavelength and guided in parallel to the substrate surface to thereby increase the quantity of infrared light incident on the infrared absorbing part, permitting implementation of high sensitivity and fast responsivity. Since the infrared detector can be formed thin, the high mechanical durability demanded in the prior art can be achieved. Besides, since the optical element and the infrared detector are formed on the same substrate, the step of assembling the optical system and the infrared detector is unnecessary; hence, it is possible to offer an ultraminiature, ultrathin infrared sensor at low cost.

### BRIEF DESCRIPTION OF THE DRAWINGS

FIG. 1A is a plan view showing a prior art example of an infrared sensor;

FIG. 1B is an enlarged sectional view, partly cut away, of the infrared sensor shown in FIG. 1A;

FIG. 2A is a sectional view, partly simplified, showing another prior art example;

FIG. 2B is a detailed sectional view of a semiconductor substrate on which the infrared sensor of FIG. 2A is formed;

FIG. 3A is a plan view illustrating a first embodiment of the infrared sensor according to the present invention;

FIG. 3B is its sectional view;

FIG. 4A is a plan view illustrating a second embodiment of the infrared sensor according to the present invention;

FIG. 4B is its sectional view;

FIG. 5A is a plan view illustrating a third embodiment of the infrared sensor according to the present invention;

FIG. 5B is its sectional view;

FIG. 6A is a plan view illustrating a fourth embodiment of the infrared sensor according to the present invention;

FIG. 6B is its sectional view;

FIG. 7A is a plan view illustrating a fifth embodiment of the infrared sensor according to the present invention;

FIG. 7B is its partly simplified sectional view;

FIG. 8 is a plan view, partly enlarged, schematically showing how infrared rays propagate through the optical element in FIG. 7A;

FIG. 9 is a sectional view showing an example 1 for comparison with the present invention;

FIG. 10 is a sectional view showing an example 2 for comparison with the present invention; and

FIG. 11 is a sectional view showing an example 3 for comparison with the present invention.

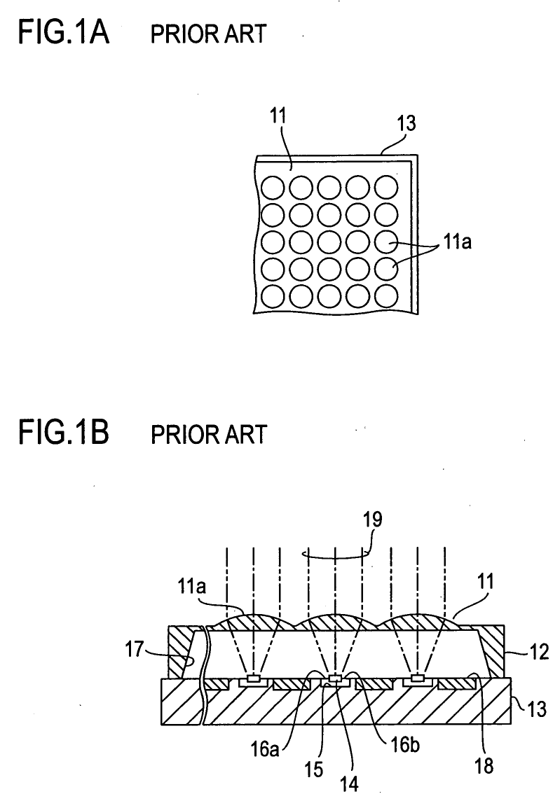

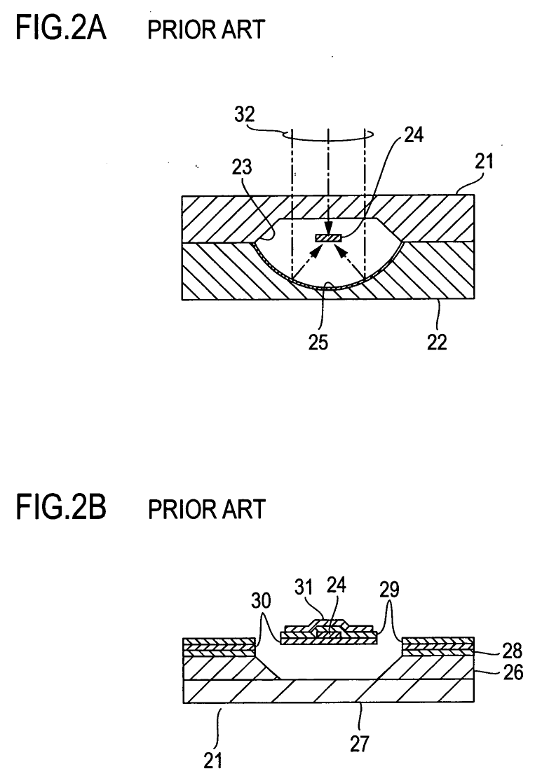

### DETAILED DESCRIPTION OF THE PREFERRED EMBODIMENTS

A description will be given first of the principles and operation of the. present invention.

Conventionally, the infrared detector usually receives infrared light incident thereon intact without changing its spot size, or receives infrared light focused through a lens to a small spot size to thereby increase the quantity of light received per unit area. The former is the case of an infrared sensor that does not use a condenser lens mainly from an economical point of view; it has been considered that focusing of infrared light through a lens is indispensable for enhanced sensitivity and responsivity. However, the use of a lens raises the problem of diffraction limited, making it impossible theoretically to focus infrared light to a spot size smaller than its wavelength. And, no attempts have been made so far to reduce the spot size by use of an optical element other than the lens.

The present invention is based on the finding that the use of an optical element, which reduces the spot size of incident infrared light on a principle different from that of the lens, remarkably increases the infrared detection sensitivity and responsivity of the infrared sensor. The principle of operation of this optical element is to deflect incident infrared light through 90° or so and confine it within the optical element thickwise thereof. Even if the area of incidence of the infrared light on the optical element is the same as in the prior art, since the spot size can be reduced to a size substantially equal to the thickness (for instance, 2 μm) of the optical element, the spot size reduction rate for the incident infrared light is one or more orders of magnitude higher than the spot size reduction rate obtainable with the lens.

Furthermore, in the case of using the lens, it was necessary that the lens be disposed on the optical axis of incident infrared light in adjacent but spaced relation to the substrate surface where the infrared detector is formed, or that the lens be disposed on the substrate surface with an intermediate layer sandwiched therebetween. In contrast to the lens, the optical element in the present invention deflect infrared light as well, and hence it can be disposed side by side with the infrared detector in the same substrate surface. Accordingly, it is possible to offer an ultrathin infrared sensor of a thickness smaller than the infrared wavelength which is impossible to achieve with the prior art. To increase the heat insulation efficiency of a hot junction of the infrared detector, it is preferable that the optical element and the infrared detector be spaced apart, but in the present invention the optical element needs only to be formed in side-by-side but spaced-apart relation to the infrared detector in the same substrate surface; therefore, the infrared sensor of the present invention can be manufactured with far more ease than in the prior art example in which the lens is disposed apart from the substrate surface.

### Embodiment 1

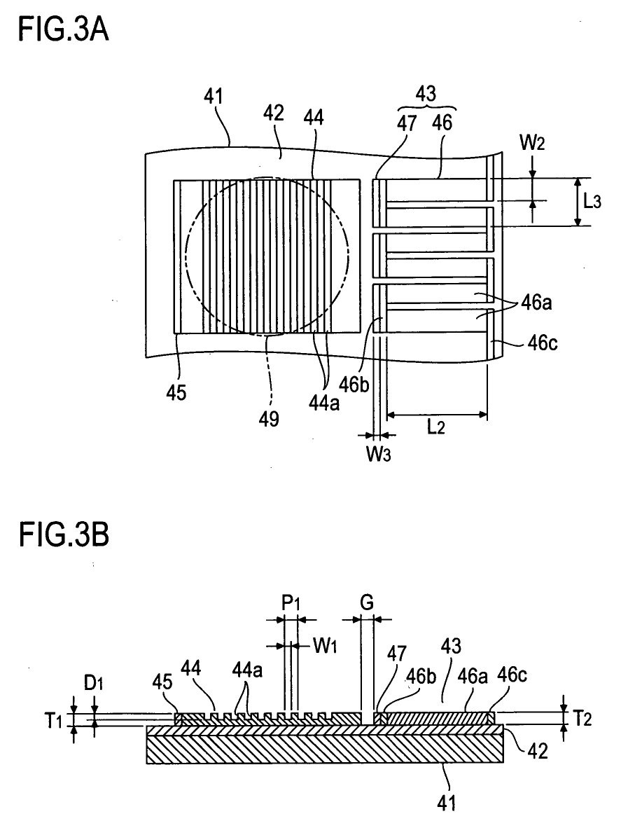

FIGS. 3A and 3B illustrate a first embodiment of the infrared sensor according to the present invention. In this embodiment a silicon (Si) substrate 41 is coated over the entire surface area thereof with an SiO₂ film 42 as an electrical and heat insulation film, on which there are disposed side by side an infrared detector 43 for converting infrared light to an electric signal and an optical element 44 for guiding the infrared light to the infrared detector 43.

The optical element 44 having an array of materials of different refractive indexes is, in this embodiment, a planar optical waveguide having a diffraction grating on the top, and the waveguide is formed of silicon. Straight grooves 44a forming the diffraction grating are formed with a pitch P₁=8 μm and each groove has a width W₁=4 μm and a depth D₁=0.5 μm, and the thickness T₁ of the optical element 44 is 2 μm.

The optical element 44 is formed by: forming a silicon film all over the surface area of the SiO₂ film 42 to a thickness of 2 μm: coating the silicon film with a resist; performing so-called line-and-space patterning of the resist; forming the straight grooves 44a by dry etching in the silicon film through the resist used as a mask; and removing the resist.

On one end face of the optical element 44 parallel to the straight grooves 44a there is formed a reflecting film 45 for reflecting infrared light. The reflecting film 45 is formed by evaporating gold (Au) in this example. Such a metal film may be substituted with an SiO₂, Ta₂O₅, or similar dielectric multi-layer film.

The infrared detector 43 is a thermopile type infrared detector composed of a thermopile 46 and an infrared absorption layer 47 for converting infrared light to heat. The infrared detector 43 is formed on the SiO₂ film 42 in opposing relation to the end face of the optical element 44 on the side opposite from the reflecting film 45. Each thermoelectric element 46a, a hot-junction-side electrode 46b and a cold-junction-side electrode 46c of the thermopile 46 are configured and arranged as shown in FIGS. 3A and 3B. That is, the hot junction and the cold junction are both located on the substrate surface, the thermoelectric element 46a is extended in parallel to the substrate surface, and the electrodes 46b and 46c are disposed at opposite ends of the thermoelectric element 46a. Such a structure of the thermoelectric element 46a makes a great difference in temperature between the both electrodes 46b and 46c, providing a high output. The thickness T₂ of the thermopile 46 formed on the SiO₂ film 42 is, in this embodiment, 2 μm that is equal to the thickness T₁ of optical element 44. The rectangular p- or n-type semiconductor forming the thermoelectric element 46a has a width W₂ of about 10 μm and a length L₂ of about 50 μm.

The infrared absorption layers 47 are each formed in contact with the hot-junction-side electrode 46b of the thermopile 46 formed opposite the optical element 44. In this embodiment the infrared absorption layer 47 has a width W₃ of 1 μm, a length L₃ of 20 μm, and a thickness of 2 μm that is equal to the thickness T₂ of the thermopile 46. The infrared absorption layer 47 is formed by vapor-deposition of blackened gold. To provide increased heat insulation of the infrared absorption layer 47, it is separated by a predetermined gap G from the optical element 44. The gap G is approximately 10 μm wide, for instance.

The optical element 44, which is a planar optical waveguide formed of silicon and provided with a diffraction grating, has an optical confinement effect that is produced by a difference in refractive index between the optical element 44 and the underlying SiO₂ film 42. Infrared light of a particular wavelength region, incident on the optical element 44 from the direction perpendicular to the substrate surface, is deflected through approximately 90° for propagation through the optical element 44 in the direction parallel to the substrate surface. In FIG. 3A, reference numeral 49 denotes the spot of infrared light incident on the optical element 44. Of the infrared rays incident on the optical element 44, those directed to the side where the infrared detector 43 is not disposed are reflected by the reflecting film 45 toward the infrared detector 43 for incidence on its infrared absorption layer 47. Accordingly, in this embodiment the incident infrared light of a particular wavelength region can be focused onto the infrared absorption layer 47 formed in the substrate surface where the optical element 44 is also formed.

In the prior art the spot size of infrared light and the length of one side of the infrared absorption part are both 100 μm or so, whereas in this embodiment the spot size of infrared light and one side of the infrared absorption part (the thickness of the infrared absorption layer 47) are diminished to 2 μm that is the silicon film thickness corresponding to the thickness of the optical waveguide forming the optical element 44, that is, one-fiftieth that in the past. In other words, since according to this embodiment even the same quantity of infrared light as in the prior art can be focused onto the infrared absorption layer 47 of far smaller thermal capacity, it is possible to increase the temperature-rise ratio of the infrared absorption layer 47, permitting implementation of higher sensitivity and faster responsivity. The thickness T₂ of the infrared detector 43 need not always to be equal to the thickness T₁ of the optical element 44 but, in this embodiment, it may be smaller than 2 μm, for instance.

### Embodiment 2

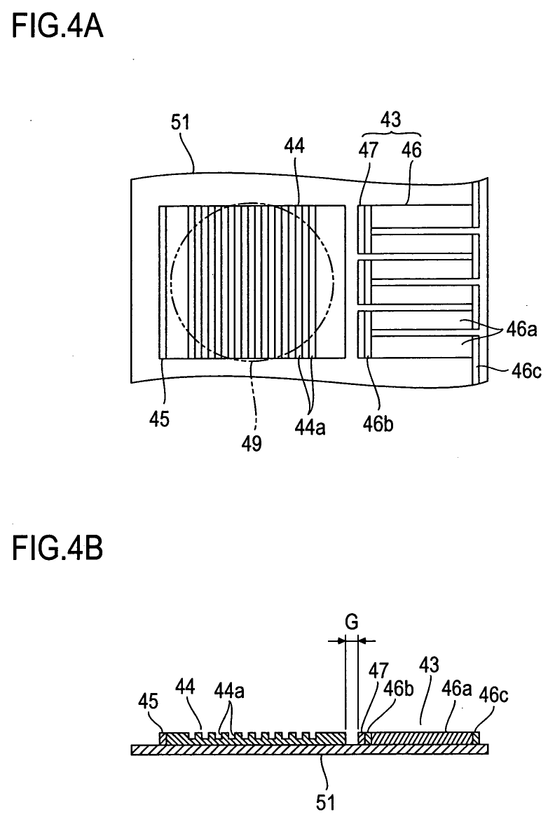

FIGS. 4A and 4B illustrate a second embodiment of the present invention, in which the substrate 41 covered with the SiO₂ film 42 of the infrared sensor shown in FIGS. 3A and 3B is substituted with a flexible plastics film 51, on which the infrared detector 43 and the optical element 44 are formed as is the case with the embodiment shown in FIGS. 3A and 3B. In this embodiment the infrared sensor is flexible.

A check was made on the durability of the infrared sensor to being of the plastics film 51 (on the degree of bending to which the function of the infrared sensor could be maintained), and it was found that the durability of the infrared sensor depends greatly on the thickness of the optical element 44. The reason for this is given below. In the infrared sensor of this embodiment the optical element 44, which occupies a large area, is formed of a semiconductor material such as silicon or dielectric material such as glass transparent to infrared rays, and since these materials are brittle, the mechanical durability decreases with an increase in thickness. A check was made on the relationship between the thickness of the optical element 44 and its durability to withstand bending. It was found that its film thickness exceeding approximately 10 μm would cause a high frequency of cracking in the optical element 44, leading to a sharp drop in its durability to withstand bending.

### Embodiment 3

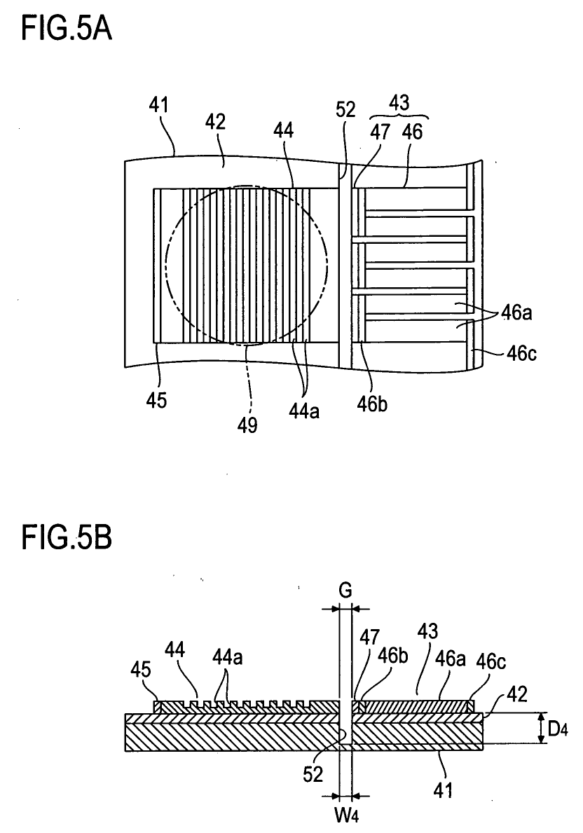

FIGS. 5A and 5B illustrate a third embodiment of the present invention, in which there is cut in the substrate 41 a deep groove 52 corresponding to the gap G between the optical element 44 and the infrared detector 43. The deep groove 52 is formed by etching, and it has a width W₄ of 10 μm and a depth D₄ of 100 μm.

The provision of the deep groove 52 suppresses the conduction of heat converted by the infrared absorption layer 47 to the optical element 44 and the substrate 41 to provide increased thermal insulation property of the infrared absorption layer 47 to further increase its temperature-rise ratio, permitting implementation of higher sensitivity and faster responsivity. In the manufacture of the infrared sensor according to this embodiment, the infrared detector 43 and the optical element 44 are formed oppositely across the deep groove 52 preformed in the substrate 41.

### Embodiment 4

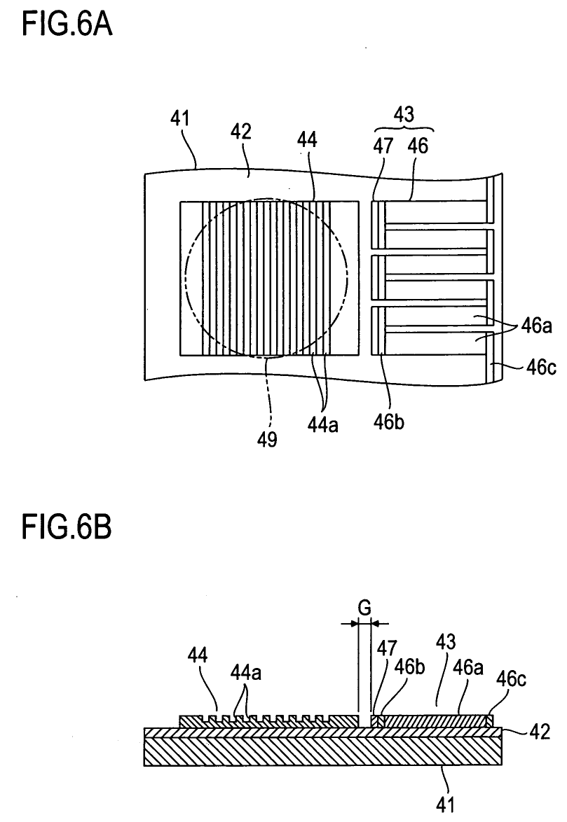

FIGS. 6A and 6B illustrate a fourth embodiment of the present invention, which does not use the reflecting film 45 coated on one end face of the optical element 44 of the infrared sensor shown in FIGS. 3A and 3B. In this embodiment, since the quantity of infrared light incident on the infrared absorption layer 47 is approximately one-half of that in the embodiment shown in FIGS. 3A and 3B, the infrared detecting sensitivity lower than that of the latter accordingly.

While in the above embodiments the optical element has been described as being a planar optical waveguide provided with a diffraction grating, a two-dimensional (2-D) photonic crystal element may be used as the optical element as described below.

### Embodiment 5

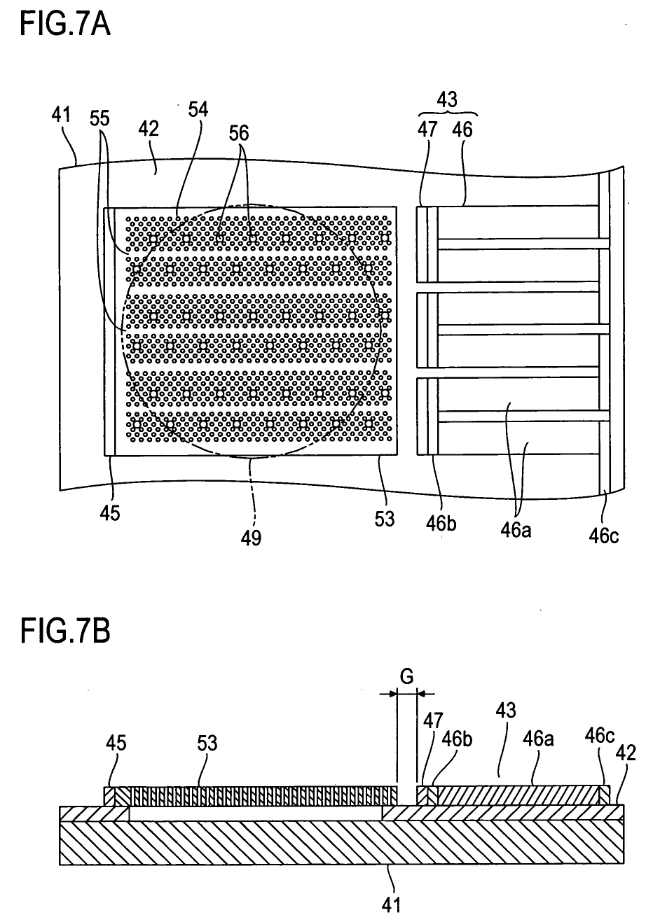

FIGS. 7A and 7B illustrate a fifth embodiment of the present invention, in which an optical element 53 is formed by a 2-D photonic crystal element, the parts corresponding to those in FIGS. 3A and 3B are identified by the same reference numerals and no description will be repeated.

The optical element 53 is formed by patterning a 2 μm-thick silicon slab. In a 2-D photonic crystal perforated or patterned with triangular lattice of holes 54 there are formed a plurality of parallel waveguides 55 defined by line defects of missing holes, and in each array of holes 54 along each waveguide 55 there are arranged, as point defects, defect holes 56 different in size from the holes 54. FIG. 7B is a schematic showing of the holes 54 with their pitch and diameter enlarged.

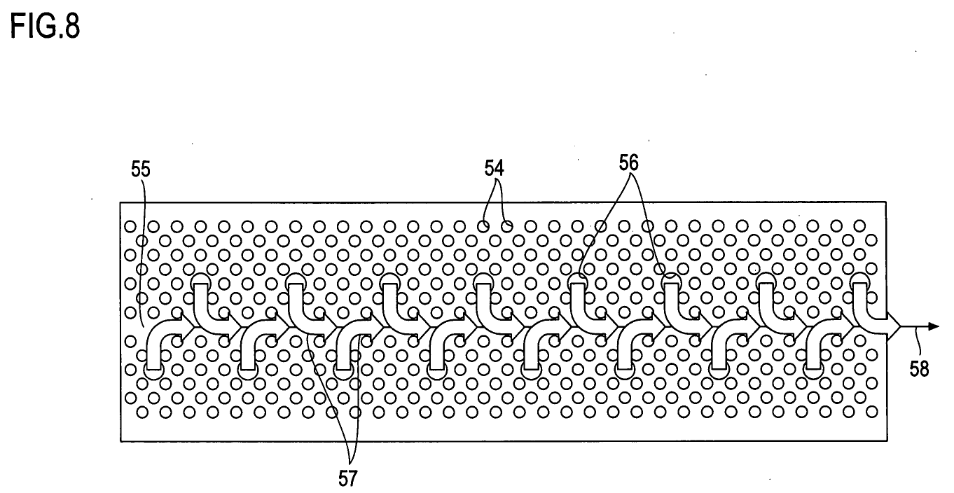

FIG. 8 shows one portion of the optical element 53 on an enlarged scale. The waveguide 55 is defined by a line defect of missing holes (an omission of one line of holes 54). The defect holes 56 are each located on either side of the waveguide 55 at the position of the hole 54 third from the waveguide 55.

The optical element 53 is formed by such a sequence of steps as described below. In the first place, silicon is deposited to a thickness of 2 μm over the entire surface area of the SiO₂ film 42, then a resist is coated all over the silicon film and exposed by electron lithography to form a pattern for forming the triangular lattice of holes 54, the waveguides 55 and the defect holes 56. Then the resist is developed to form resist masks, through which the silicon film is selectively etched away by dry etching. Then the resist masks are removed, and the SiO₂ film 42 underlying the silicon film remaining unremoved is removed by selective etching to form a silicon slab sandwiched between air layers. In this embodiment the holes 54 are 2.3 μm in diameter and disposed at intervals of 4 μm, and the defect holes 56 are 4.6 μm in diameter.

The defect holes 56 formed in the silicon film has a function of coupling infrared light of only a particular wavelength to the adjoining waveguide 55. That is, of the infrared rays incident on the optical element 53 vertically thereto, the infrared light of only a particular wavelength couples to the waveguide 55, then changes the direction of travel through 90°, then propagates through the waveguide 55 formed by the 2-μm-thick silicon layer, and finally reaches the infrared absorption layer 47. The infrared light coupled to the waveguide 55 propagates therethrough in parallel to the silicon layer without propagation loss because it is controlled in the direction parallel to the silicon layer by the optical confinement effect of the triangular periodic pattern of holes 54 and in the direction vertical to the plane of the silicon layer by the optical confinement effect based on the difference in refractive index between the silicon layer and the air layer. Of the infrared rays incident on the optical element 53, the infrared light directed outside the optical element 53 reflects off the reflecting film 45 on the one end face of the optical element 53, then propagates toward the infrared detector 43, and reached the infrared absorption layer 47. Thus the incident infrared light of a particular wavelength region can be focused onto the infrared absorption layer 47 formed in the substrate surface common to the optical element 53. In FIG. 8 the arrows 57 schematically show coupling of the infrared rays of a particular wavelength incident on the defect holes 56 to the waveguide 55, and the arrow 58 indicates the direction of propagation of the infrared light in the waveguide 55.

As described previously, the spot size of infrared light and the length of one side of the infrared absorbing part are both 100 μm or so, whereas in this embodiment the spot size of infrared light and the length of one side of the infrared absorption layer 47 are reduced down to 2 μm that is the film thickness of the silicon layer corresponding to the thickness of the waveguide of the optical element 53. In the case where 20% of incident infrared light is incident on the defect holes 56 and couples to the waveguide 55 at 50% efficiency, 10% of infrared light can be focused to a spot size of 2 μm. The quantity of infrared light incident on the infrared absorption layer 47 per unit area in this embodiment is five times larger than in the prior art example in which the spot size of incident infrared light is 100 μm. Accordingly, this embodiment also permits focusing infrared light onto the infrared absorption layer 47 of thermal capacity far smaller than in the prior art, and hence it increases the temperature-rise ratio of the infrared absorption layer 47, making it possible to achieve higher sensitivity and faster responsivity.

While in the above embodiments the gap G between the optical element 44 or 53 and the infrared absorption layer 47 and the deep groove 52 formed in the substrate 41 have been as being air layers, they may also be inert gas or vacuum layers. This can be done by filling a case with an inert gas or vacuum sealing it after encasing the entire structure of the sensor.

### COMPARATIVE EXAMPLES

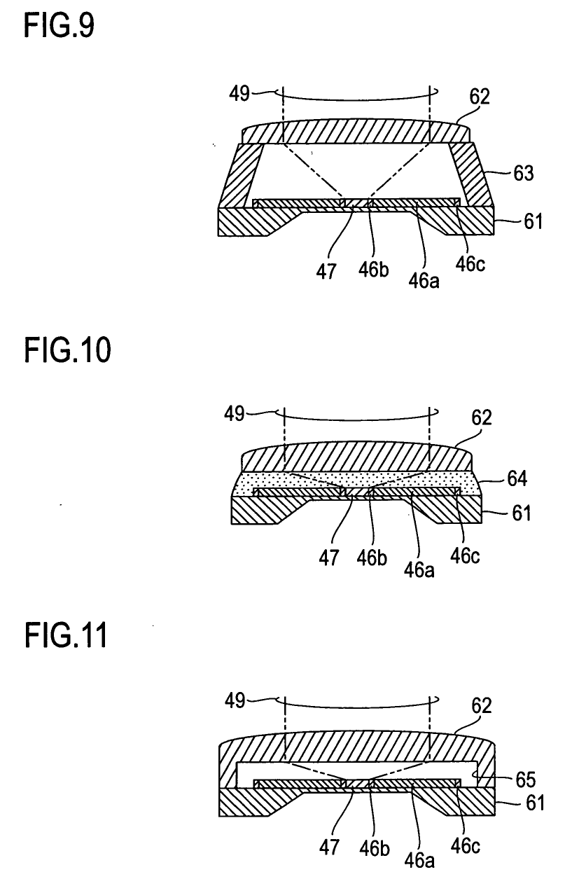

FIGS. 9 to 11 illustrate configurations of comparative examples 1 to 3 designed for comparison with the embodiments of the present invention described above. The infrared sensor of FIG. 9 employs the same infrared detector as that used in Embodiment 1 but uses a convex lens in place of the optical element 44. In FIG. 9, reference numeral 61 denotes a substrate, 62 a lens and 63 a spacer.

Embodiment 1 of FIGS. 3A and 3B was compared with comparative example 1 in terms of the efficiency, sensitivity and outer dimensions of respective elements. In Embodiment 1 the temperature difference between the hot and cold junctions of the thermoelectric element 46a, caused when infrared light of a 10-μm wavelength incident on the sensor was focused onto the infrared absorption layer 47, was approximately five times larger than in comparative example 1. In terms of the thicknesses of elements, the infrared detector 43 and the optical element 44 were both 2 μm or so in Embodiment 1, whereas in comparative example 1 the distance from the infrared absorption layer 47 to the top end of the lens 62 was required to be 1 mm or more. Furthermore, a check was made on the positional displacement of the focused beam by the lens 62. In comparative example 1, the assembling accuracy strongly affects focusing of the beam because of the long distance between the lens 62 and the infrared detector, whereas in Embodiment 1 no misalignment occurred between the optical axes of the infrared detector 43 and the optical element 44 because they are formed on the same substrate.

From the above, it is seen that the infrared sensor of the present invention is highly sensitive, small in the outer dimensions of respective elements, and excellent in productivity because of its essentially high assembling accuracy.

Next, a description will be given, with reference to FIGS. 9 to 11, of the ease with which the gap is formed between the infrared detector and the optical element. In the case of using the lens 62, it is required to be disposed at a position separated from the substrate 61 in the direction normal thereto. To this end, the lens 62 produced separately of the substrate 61 having formed thereon the infrared detector must be assembled with the substrate 61 (FIG. 9). With this method, since the sensitivity of the infrared sensor depends on the assembling accuracy, the manufacturing process is complex, leading to an increase in manufacturing costs. The need for the assembling step could be eliminated by laminating the lens 62 on the infrared detector through a thermal insulating film 64 as of SiO₂ or SiNₓ as in comparative example 2 of FIG. 10. However, the thermal conductivity of such a material as SiO₂ or SiNₓ is low, but it is one or more orders of magnitude higher than the thermal conductivity of the gap formed by an air or vacuum layer, and consequently efficient thermal insulation is hard to achieve between the lens 62 and the infrared detector. A possible solution to this problem is shown in comparative example 3 of FIG. 11, in which the lens 62 is once formed on the thermal insulating film and then only the thermal insulating film is etched away to form a gap 65 by an air layer. However, selective etching-away of only the thermal insulating film involves the formation of a protective film and hence complicates the manufacturing process, constituting a factor to reduction of yields. From the above it is seen that the infrared sensor of the present invention allows more ease than the prior art in the formation of that gap for providing a high degree of thermal insulation between the optical element and the infrared detector which is requisite for implementation of high sensitivity and fast responsivity of the sensor.

1. An infrared sensor comprising:
an infrared detector for converting infrared light to an electric signal; and
an optical element for guiding the infrared light to said infrared detector;
wherein:
said optical element has an array of materials of different refractive indexes and is formed in the surface of a substrate side by side with said infrared detector; and
infrared light incident on said optical element from a direction vertical to the surface of said substrate is deflected and guided by said optical element in parallel to the surface of said substrate for incidence on said infrared detector.

2. The infrared sensor of claim 1, wherein:
said optical element is a planar optical waveguide provided with a diffraction grating.

3. The infrared sensor of claim 1, wherein:
said optical element is a two-dimensional photonic crystal element provided with a plurality of line-defect waveguides and point defects arranged along each of said plurality of line-defect waveguides.

4. The infrared sensor of claim 2 or 3, wherein:
said infrared detector comprises: a thermopile having both hot and cold junctions located on the surface of said substrate; and an infrared absorption layer disposed near said hot junction.

5. The infrared sensor of claim 4, wherein:
said optical element and said infrared absorption layer are separated by a gap.

6. The infrared sensor of claim 5, wherein:
said substrate has cut therein a groove corresponding to said gap.

7. The infrared sensor of any one of claims 1 to 3, wherein:
a reflector for reflecting infrared light is formed on the end face of said optical element on the side opposite the end face of said optical element near said infrared detector.

8. The infrared sensor of claim 4, wherein:
a reflector for reflecting infrared light is formed on the end face of said optical element on the side opposite the end face of said optical element near said infrared detector.

9. The infrared sensor of claim 5, wherein:
a reflector for reflecting infrared light is formed on the end face of said optical element on the side opposite the end face of said optical element near said infrared detector.

10. The infrared sensor of claim 6, wherein:
a reflector for reflecting infrared light is formed on the end face of said optical element on the side opposite the end face of said optical element near said infrared detector.
